(19) United States
(12) Patent Application Publication
(10) Pub. No.: US 2016/0344790 A1
(43) Pub. Date: Nov. 24, 2016

(54) WIRELESS COMMUNICATION DEVICE AND WIRELESS COMMUNICATION METHOD

(71) Applicant: FUJITSU LIMITED, Kawasaki-shi (JP)

(72) Inventor: Akira Takamune, Kawasaki (JP)

(21) Appl. No.: 15/132,561

(22) Filed: Apr. 19, 2016

(30) Foreign Application Priority Data
May 20, 2015 (JP) 2015-103028

(51) Int. Cl. H04L 29/06; H04M 3/22

(52) U.S. Cl. CPC H04L 65/608; H04M 3/2227

(57) ABSTRACT

A device includes a processor configured to acquire moving image data, monitor communication quality of wireless communication between an output device and, the wireless communication device, generate, according to first coding processing of the moving image data, first coded data including a reference frame and a first difference frame when the communication quality is greater than a threshold value, the reference frame being coded from intra-frame information, and the first difference frame being coded by referencing the reference frame, generate, according to second coding processing, second coded data including a second difference frame when the communication quality is less than or equal to the threshold value, the second difference frame being coded by referencing an already-transmitted reference frame already transmitted to the output device and containing data of a block within the already-transmitted reference frame, and transmit the first coded data or the second coded data.

### CROSS-REFERENCE TO RELATED APPLICATION

This application is based upon and claims the benefit of priority of the prior Japanese Patent Application No. 2015-103028, filed on May 20, 2015, the entire contents of which are incorporated herein by reference.

### FIELD

The embodiments discussed herein are related to a wireless communication device and a wireless communication method.

### BACKGROUND

In recent years, there has been prevalent a technology for transmitting, by wireless communication, contents such as, for example, videos and audios, reproduced by wireless communication devices such as a smartphone and a tablet terminal, to output devices such as a television, a display, and a speaker, thereby causing the contents to be output. In, for example, the smartphone, the tablet terminal, and so forth, source functions of Wi-Fi Display (Miracast) are increasingly installed as standard functions. Note that the “source” may be an apparatus that has a function of transmitting, for example, videos and audios, reproduced by a wireless communication device, to a sink apparatus by the wireless communication. The wireless communication may be performed via, for example, a wireless local area network (LAN) or the like. In addition, the “sink” may be an output device that has a function of outputting, for example, videos and audios, received from an apparatus having a source function, and may include a television, a display, a speaker, and so forth.

In Miracast, to transmit video contents, an MPEG2-TS container format is used. Note that MPEG2 is the abbreviation of Moving Picture Experts Group 2. The TS is the abbreviation of a transport stream. In the MPEG2-TS container format, for example, an H.264 codec is used for a video codec. In addition, for example, AAC is used for an audio codec. The AAC is the abbreviation of advanced audio coding. The H.264 codec may include three types of frame of, for example, an intra-coded frame (I frame), a predictive-coded frame (P frame), and a bidirectional-predictive-coded frame (B frame).

The I frame is generated based on a result of intra-frame prediction (intra prediction). The I frame is, for example, a self-contained frame able to be single-handedly decoded without referencing another frame and is used as an initial image of a video sequence. The I frame is used as, for example, a starting point of a new viewer or a resynchronization point in a case where a transmitted bit stream is damaged. The I frame is used for implementing, for example, fast-forward, rewind, and another random access function and the I frame may be automatically inserted at given intervals. The I frame is, for example, a frame whose data amount tends to become the largest among the three frames. Note that, in the following description, the I frame is able to be decoded without referencing another frame and a frame such as, for example, the I frame, referenced in decoding of another frame, is called a reference frame in some cases.

The P frame is, for example, a frame transmitted by coding a difference between frames by using inter-frame prediction (inter prediction) based on a previous frame. The B frame is, for example, a frame transmitted by coding a difference between frames by using the inter-frame prediction based on a previous frame and a future frame. Since transmitting a difference between frames, the B frame tends to only have to transmit a data amount less than that of, for example, the I frame. However, since, in order to be decoded, referencing other frames such as the P frame and the I frame, the B frame is easily influenced by a transmission error. In addition, since, in order to be decoded, referencing another frame, the P frame is easily influenced by a transmission error in the same way as the B frame. Note that, in the following description, a frame such as the B frame or the P frame, which references another frame in order to be decoded, is called a difference frame in some cases.

Regarding this, there is known a technology for providing a transmission device that is able to efficiently perform transmission and that is able to successfully process and recover a transmission error even if such an error occurs (see, for example, Japanese Laid-open Patent Publication No. 63-199572). In addition, there is known a technology for enabling to avoid a reference image mismatch in a case where the head of a sequence is the P picture and a picture skip in a case where the head of a sequence is the I picture (see, for example, Japanese Laid-open Patent Publication No. 11-41609).

### SUMMARY

According to an aspect of the invention, a wireless communication device includes a memory and a processor coupled to the memory and configured to acquire moving image data, monitor communication quality of wireless communication between an output device and the wireless communication device, generate, according to first coding processing of the moving image data, first coded data including a reference frame and a first difference frame when the communication quality is greater than a threshold value, the reference frame being coded from intra-frame information, and the first difference frame being coded by referencing the reference frame, generate, according to second coding processing of the moving image data, second coded data including a second difference frame when the communication quality is less than or equal to the threshold value, the second difference frame being coded by referencing an already-transmitted reference frame already transmitted to the output device and containing data of a block within the already-transmitted reference frame, and transmit one of the first coded data and the second coded data to the output device using the wireless communication.

The object and advantages of the invention will be realized and attained by means of the elements and combinations particularly pointed out in the claims.

It is to be understood that both the foregoing general description and the following detailed description are exemplary and explanatory and are not restrictive of the invention, as claimed

### BRIEF DESCRIPTION OF DRAWINGS

FIG. 1 is a diagram for explaining a flow of transmission processing of contents, based on exemplified Miracast;

FIG. 2 is a diagram exemplifying a configuration of frames in H.264;

FIG. 3 is a diagram exemplifying a case were an I frame is not normally received by a sink apparatus;

FIG. 4 is a diagram exemplifying a functional block configuration of a source apparatus according to a first embodiment;

FIG. 5 is a diagram exemplifying another functional block configuration of the source apparatus according to the first embodiment;

FIG. 6 is a diagram exemplifying an operation sequence of transmission processing of contents according to the first embodiment;

FIG. 7 is a diagram for explaining insertion of data of some drawing blocks of a reference frame into difference frames;

FIG. 8 is a diagram for explaining processing for reducing a block size of a drawing block;

FIG. 9 is a diagram exemplifying macroblock sizes selectable in H.264;

FIG. 10 is a diagram exemplifying an operation flow of transmission processing of contents according to the first embodiment;

FIG. 11 is a diagram exemplifying an operation flow of transmission processing of contents according to a second embodiment;

FIG. 12 is a diagram exemplifying coding setting information according to the second embodiment; and

FIG. 13 is a diagram exemplifying a hardware configuration of a source apparatus according to an embodiment.

### DESCRIPTION OF EMBODIMENTS

Owing to interference of a radio wave or the like, based on, for example, use of multi-channel transmission, the communication quality of wireless communication is lowered in some cases. If the communication quality is lowered, for example, a reference frame, whose data amount is large, within video data transmitted to an output device by a wireless communication device is not normally received by the output device and block noises are generated in a display screen of the output device, thereby causing a state in which a video is not normally displayed. In this case, a difference frame decoded by referencing another frame such as, for example, a B frame or a P frame includes no video information of an entire screen. Therefore, over a time period, such as a time period before a subsequent reference frame is received, an event in which the video remains disturbed occurs in some cases. In one aspect, an object of the present technology is to promptly restore a video in a case where disturbances are generated in the video received and output by an output device.

Hereinafter, some embodiments of the present technology will be described in detail with reference to drawings. Note that the same symbol will be assigned to a corresponding element in drawings.

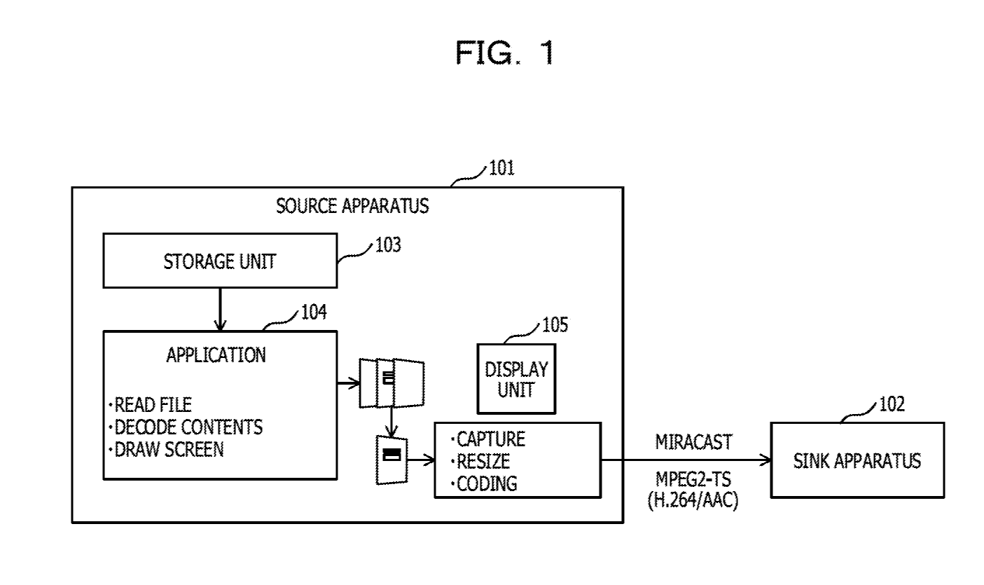

FIG. 1 is a diagram for explaining a flow of transmission processing of contents from a source apparatus 101 to a sink apparatus 102, based on exemplified Miracast. Note that the source apparatus 101 may be a wireless communication device equipped with a wireless communication function and may be, for example, a smartphone, a mobile phone, a tablet terminal, or the like. In addition, the sink apparatus 102 may be an output device such as, for example, a television, a display, or a speaker, equipped with a wireless communication function. In addition, it is assumed that an instruction to reproduce a content is input in, for example, an application 104 executed by the source apparatus 101. In this case, the application 104 reads a file of the content, stored in an storage unit 103, and decodes the content, thereby performing drawing the content on a display screen of a display unit 105 included in the source apparatus 101. In addition, in a case where an instruction to perform Miracast is input, the application 104 captures image data used for drawing on the display screen of the display unit 105. In addition, the application 104 resizes and codes a captured image into the MPEG2-TS container format and transmits the coded image to the sink apparatus 102. Note that, in the MPEG2-TS container format, the video data of the content is coded by, for example, the H.264 codec and audio data thereof is coded by an advanced audio coding (AAC) codec.

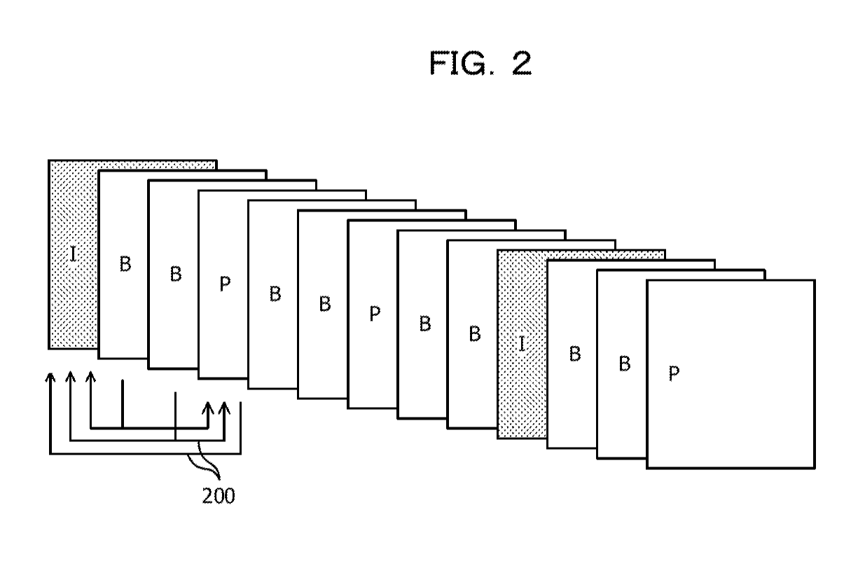

FIG. 2 is a diagram exemplifying a configuration of frames in H.264. In H.264, the frames include three types of frame of, for example, an intra-coded frame (I frame), a predictive-coded frame (P frame), and a bidirectional-predictive-coded frame (B frame). In addition, in FIG. 2, arrows 200 each express a frame of a reference destination at the time of coding, and the B frames each reference the corresponding I frame and the corresponding P frame. In addition, the P frames each reference the corresponding I frame. Each of the I frames does not reference another frame, is a self-contained frame able to be single-handedly decoded, and is used as, for example, an initial image of a video sequence. Therefore, the I frame tends to have a large data amount among the three frames.

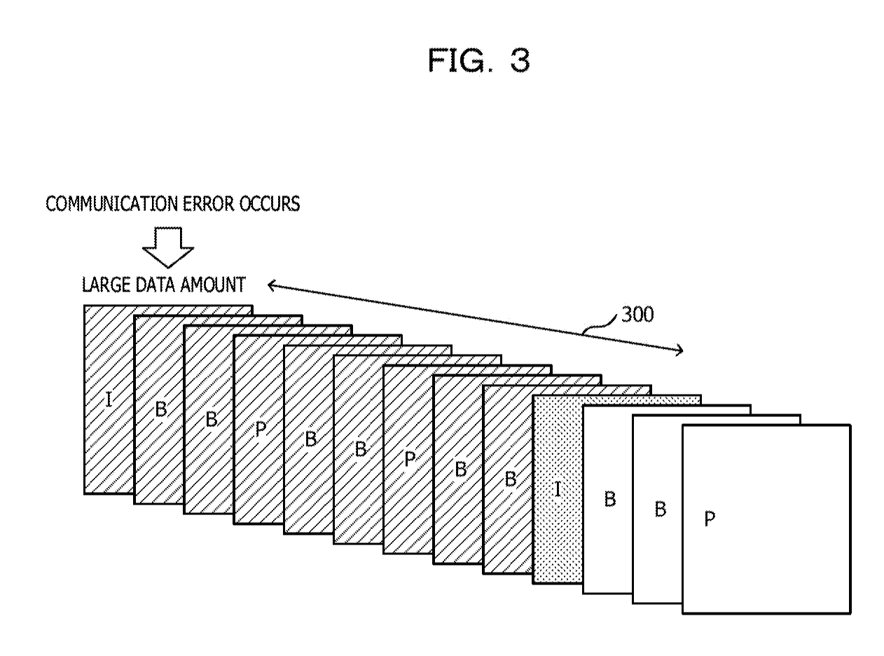

In addition, FIG. 3 is a diagram exemplifying a case where an I frame is not normally received by the sink apparatus 102 in transmission of contents from the source apparatus 101 to the sink apparatus 102. Owing to interference of a radio wave or the like, based on, for example, use of multi-channel transmission, the communication quality of wireless communication is noticeably deteriorated in some cases. In this case, an increase in transmission errors of communication packets or a decrease in a link speed occurs, and owing to this, communication packets are deteriorated. Accordingly, for example, an I frame whose data amount is large is not normally received by the sink apparatus 102 in some cases. Note that the link speed may be a communication speed of communication between, for example, the source apparatus 101 and the sink apparatus 102. In addition, the transmission errors may be events in which packets transmitted to the sink apparatus 102 by, for example, the source apparatus 101 are not normally received by the sink apparatus 102. In this case, difference frames such as the B frames and the P frames, received after that, include no video information of an entire screen and each reference the corresponding I frame at the time of being decoded. Therefore, even if the difference frames such as the B frames and the P frames, each of which tends to have a data amount smaller than that of the corresponding I frame, are normally received, reception of no I frame causes the entire screen to be difficult to normally decode from the difference frames. In addition, over, for example, a time period (for example, a time period of an arrow 300 in FIG. 3), a state in which block noises are generated in a display screen and a video is disturbed and is not normally reproduced occurs in some cases. Note that frames indicated by diagonal lines each express a frame, not normally reproduced.

In addition, if the subsequent I frame is normally received, the disturbances in the video are recovered. However, depending on a communication state, the subsequent I frame may be abnormally received. As a result, an event in which a user views the content over a long time period in a state in which the video is not restored. Therefore, in a first embodiment described hereinafter, in a case where the communication quality is lowered, the source apparatus 101 causes at least one drawing block within a reference frame such as, for example, the corresponding I frame to be contained in a difference frame such as the corresponding B frame or the corresponding P frame and transmits the drawing block. Note that the drawing block may be, for example, a block serving as a coding unit and may be a macroblock in H.264. From this, using data of the drawing block of the corresponding reference frame, contained in the corresponding difference frame and received, the sink apparatus 102 is able to redraw and restore an area corresponding to the drawing block within the video, in which a block noise is generated. Accordingly, in a case where disturbances are generated in the video received and output by the output device on a sink side, the source apparatus 101 is able to promptly restore the video. Hereinafter, the first embodiment will be described.

### First Embodiment

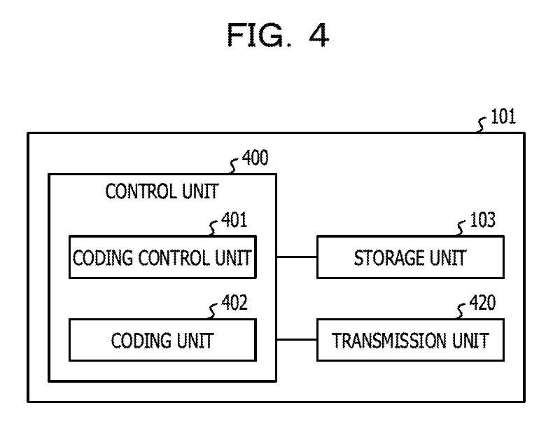

FIG. 4 is a diagram exemplifying a functional block configuration of the source apparatus 101 according to the first embodiment. The source apparatus 101 includes, for example, a control unit 400, the storage unit 103, and a transmission unit 420. The control unit 400 includes functional units such as, for example, a coding control unit 401 and a coding unit 402. The storage unit 103 in the source apparatus 101 may store therein pieces of information such as, for example, a program and coding setting information 1200 described later. The coding unit 402 may perform coding of, for example, a content, and the coding control unit 401 may control coding based on the coding unit 402. In accordance with an instruction of the control unit 400, the transmission unit 420 performs communication with the sink apparatus 102. More details of these individual functional units and information stored in the storage unit 103 will be described later.

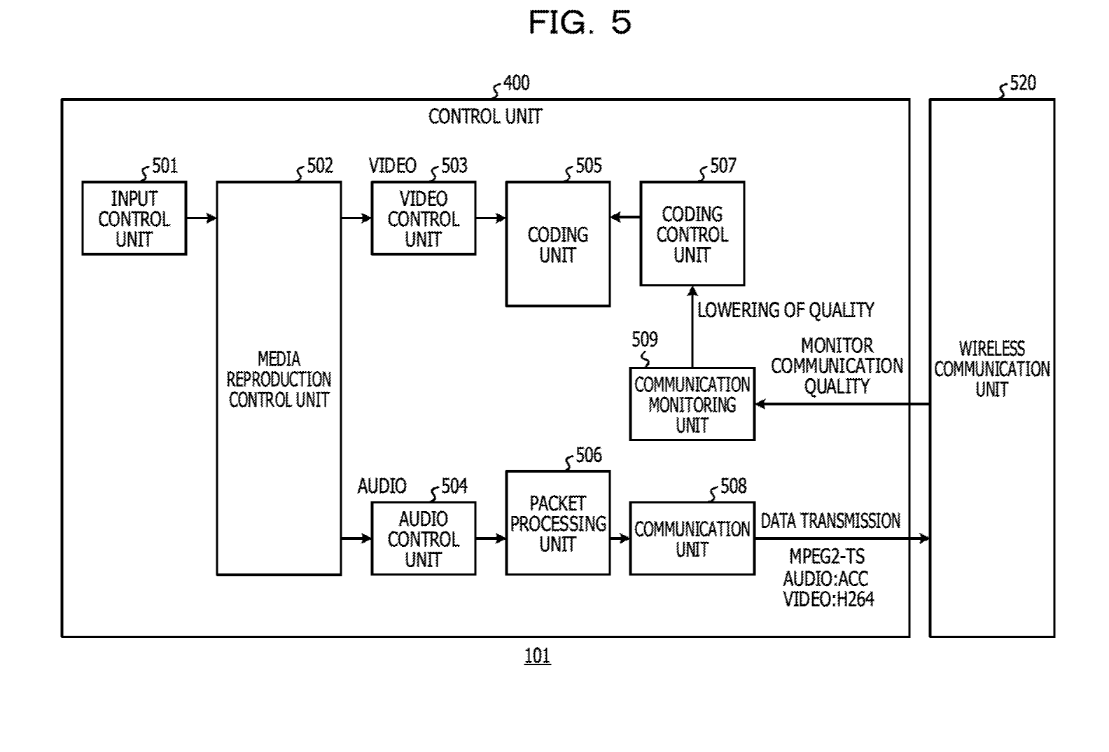

FIG. 5 is a diagram exemplifying another functional block configuration of the source apparatus 101 according to the first embodiment. In FIG. 5, the source apparatus 101 includes, for example, a control unit 400 and a wireless communication unit 520. The control unit 400 in the source apparatus 101 includes, for example, an input control unit 501, a media reproduction control unit 502, a video control unit 503, an audio control unit 504, a coding unit 505, a packet processing unit 506, a coding control unit 507, a communication unit 508, and a communication monitoring unit 509. The input control unit 501 may be, for example, an application such as a media player, which operates on the source apparatus 101, and may function as an interface with a user. In a case where an instruction to output, based on, for example, Miracast, a content to the sink apparatus 102 is input by the user, the input control unit 501 outputs a reproduction request to the media reproduction control unit 502. The media reproduction control unit 502, to which the reproduction request is input, sorts data of the content into, for example, two codecs of video data and audio data, thereby delivering the video data to the video control unit 503 and delivering the audio data to the audio control unit 504. The video control unit 503 decodes and delivers the delivered video data to the coding unit 505. The coding unit 505 performs processing for coding the video data into a format used in outputting the video data in Miracast. The audio control unit 504 decodes and delivers the audio data to the packet processing unit 506. The audio data and the coded video data are delivered to the packet processing unit 506 and packetized in order to be output to the exterior. Note that packets may be created based on, for example, a container format of MPEG2-TS.

The packetized data is delivered to the communication unit 508 and is output to the sink apparatus 102 via the wireless communication unit 520. Note that communication between the wireless communication unit 520 and the sink apparatus 102 may be performed using an RTP via a wireless LAN and the like. Note that the RTP is the abbreviation of a real-time transport protocol. The communication monitoring unit 509 may monitor, for example, the communication quality (for example, a link speed, a packet loss rate, a packet retransmission rate, and so forth) of communication between the wireless communication unit 520 and the sink apparatus 102 with a predetermined period. The link speed may be, for example, a communication speed of communication between the source apparatus 101 and the sink apparatus 102. The packet loss rate may be, for example, the proportion of packets not normally received by the sink apparatus 102 to packets transmitted to the sink apparatus 102 by the source apparatus 101. The packet retransmission rate may be, for example, the proportion of packets for which a retransmission request is received from the sink apparatus 102 to the packets transmitted to the sink apparatus 102 by the source apparatus 101. Note that the sink apparatus 102 may transmit a retransmission request to the source apparatus 101 for packets not normally received.

In addition, in a case where the communication quality is lowered to fall below, for example, a predetermined quality, the communication monitoring unit 509 notifies the coding control unit 507 of information indicating that the communication quality is lowered. Upon receiving, from the communication monitoring unit 509, a notice of the information indicating that the communication quality is lowered, the coding control unit 507 instructs the coding unit 505 to change coding processing of the video data. In accordance with the instruction from the coding control unit 507, the coding unit 505 changes coding processing of a content, thereby performing coding. In a case of, for example, being instructed to change the coding processing, the coding unit 505 may change the coding processing based on the coding unit 505 so as to insert, into a difference frame, a part of data (for example, a macroblock unit of data) of a reference frame finally output to the sink apparatus 102. From this, by using the part of data of the corresponding reference frame, inserted into the corresponding received difference frame, the sink apparatus 102 is able to redraw an image of an area within a frame, which corresponds to the part of data. Accordingly, even in a case where the quality of communication between, for example, the source apparatus 101 and the sink apparatus 102 is lowered and disturbances are generated in a reproduced video in the sink apparatus 102, it is possible to decrease a time taken to restore the video reproduced by the sink apparatus 102.

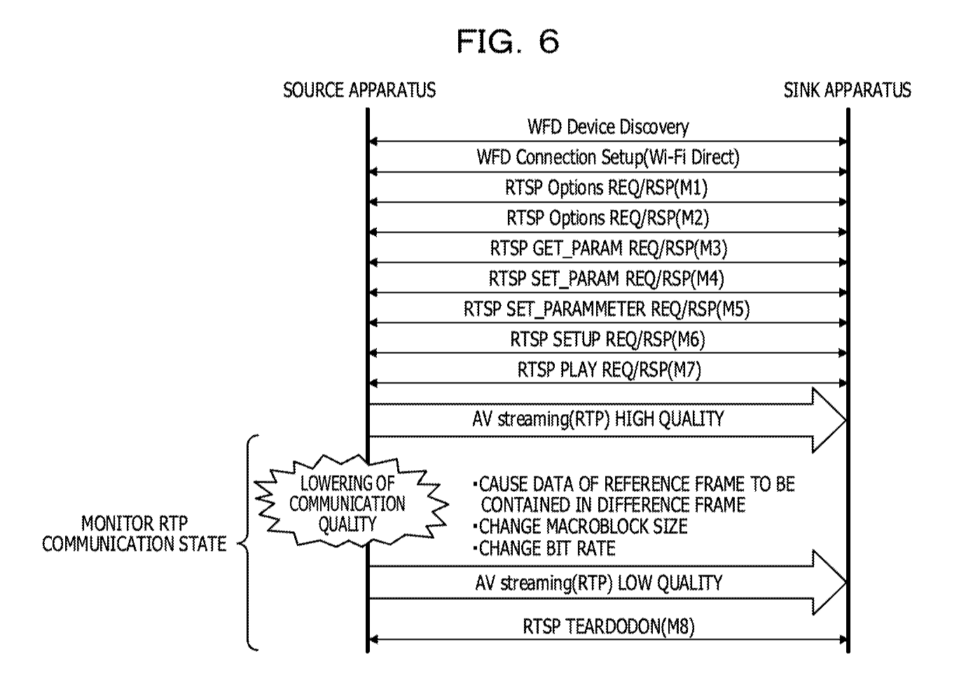

FIG. 6 is a diagram exemplifying an operation sequence of transmission processing of contents according to the first embodiment. In a case of reproducing a content by Miracast, a connection is established between the source apparatus 101 and the sink apparatus 102 by using Wi-Fi Direct. Subsequently, by using an RTSP, the source apparatus 101 and the sink apparatus 102 exchange functions of supporting each other's apparatuses and information of performance with each other. Note that the RTSP is the abbreviation of a real time streaming protocol. After that, the source apparatus 101 initiates AV streaming and transmits RTP packets to the sink apparatus 102, thereby transmitting video data and audio data of contents to the sink apparatus 102. In addition, in the first embodiment, upon initiating the AV streaming, the source apparatus 101 monitors the communication quality of RTP packets transmitted to the sink apparatus 102. In a case of detecting lowering of the communication quality, the source apparatus 101 codes contents by changing the coding processing thereof and transmits the contents to the sink apparatus 102. Note that the lowering of the communication quality may be detected based on, for example, a decrease in the link speed, an increase in the packet loss rate, an increase in the retransmission rate of packets, or the like.

In addition, the changing of the coding processing may be as, for example, follows.

(1) Data of a drawing block of a reference frame of video data is contained in a difference frame, and the difference frame is transmitted.

(2) The sizes of drawing blocks of the video data are reduced.

(3) The bit rate of the video data is decreased, thereby performing coding.

Accordingly, in, for example, the sink apparatus 102, without waiting for reception of a subsequent reference frame, it is possible to redraw a corresponding screen area by using data of a drawing block of the corresponding reference frame, contained in the corresponding difference frame. Note that the drawing block may be, for example, a block serving as a unit of coding and may be a macroblock in H.264. In addition, by reducing the size of, for example, a drawing block serving as a unit of data of the corresponding reference frame contained in the corresponding difference frame, it is possible to finely adjust the data size of data of the corresponding reference frame contained in the corresponding difference frame. Therefore, it is possible to reduce the data size of, for example, a transmitted frame. In addition, furthermore, the bit rate of the video data is decreased, and the video data is coded, thereby enabling the data size of the transmitted frame to be reduced. In addition, by reducing the data size of the frame, even in a case where the quality of communication between the source apparatus 101 and the sink apparatus 102 is lowered, it is possible to enhance the possibility that the data of the frame is normally received by the sink apparatus 102.

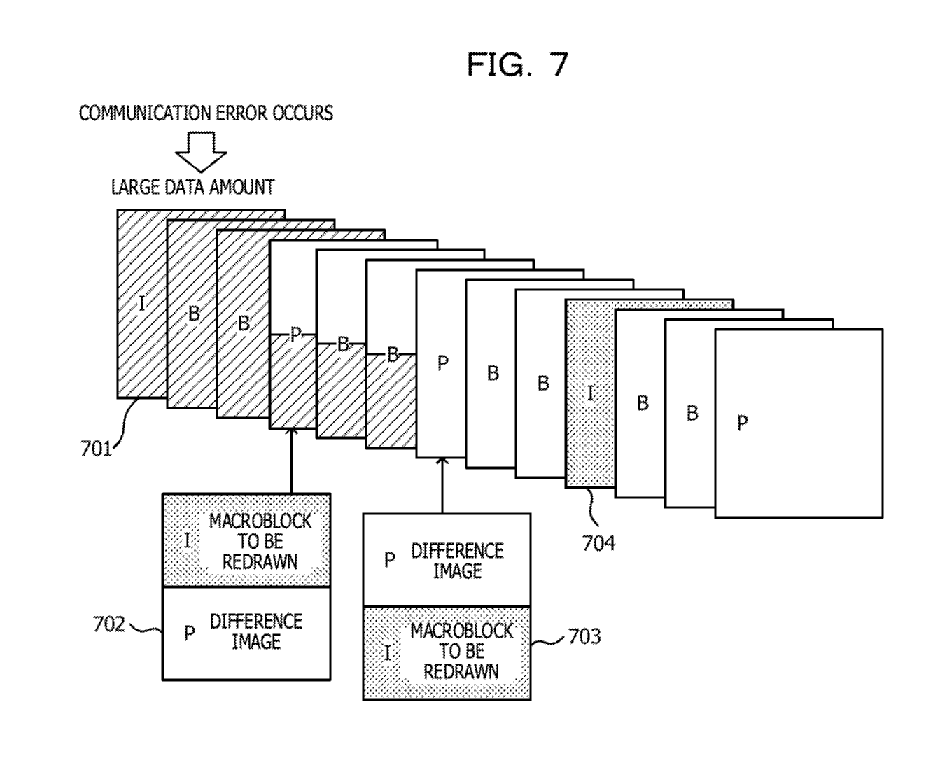

FIG. 7 is a diagram for explaining insertion of data of some drawing blocks of a reference frame into difference frames in a case where the above-mentioned communication quality is lowered. It is assumed that lowering of, for example, the communication quality or the like causes a transmission error to be generated in a first reference frame 701 at a left end in FIG. 7 and the first reference frame 701 is not normally delivered to the sink apparatus 102. In this case, the source apparatus 101 causes data of, for example, a drawing block (for example, a macroblock) of the first reference frame, finally transmitted to the sink apparatus 102, to be contained in data of the corresponding difference frame such as the B frame or the P frame, and the source apparatus 101 transmits the data of the drawing block of the first reference frame. In, for example, FIG. 7, the source apparatus 101 causes data of macroblocks, which correspond to an upper half of a screen area of the first reference frame, to be contained in a first difference frame 702 and transmits the data of macroblocks to the sink apparatus 102. In addition, the source apparatus 101 causes data of macroblocks, which correspond to a lower half of the screen area of the first reference frame, to be contained in a second difference frame 703 and transmits the data of macroblocks to the sink apparatus 102. Accordingly, in the sink apparatus 102, at a time point when receiving the first difference frame 702, it is possible to redraw and restore the upper half of the screen area by using the data of the upper half of the screen area of the first reference frame 701, contained in the first difference frame 702. In addition, in the same way, at a time point when receiving the second difference frame 703, it is possible for the sink apparatus 102 to redraw and restore the lower half of the screen area by using the data of the lower half of the screen area of the first reference frame 701, contained in the second difference frame 703. Accordingly, without waiting for reception of a subsequent second reference frame 704, it is possible for the sink apparatus 102 to restore a whole image within a frame at a time point when receiving, for example, the second difference frame 703. Note that while, in FIG. 7, an example in which data of some drawing blocks of the corresponding reference frame is inserted into the corresponding P frame is illustrated, data of some drawing blocks of the corresponding reference frame may be inserted into another difference frame such as the corresponding B frame. In addition, the data of some drawing blocks of the corresponding reference frame inserted into the corresponding difference frame may be data of one drawing block or data of drawing blocks. The number of drawing blocks of the corresponding reference frame inserted into the corresponding difference frame may be set to, for example, a predetermined number so that the corresponding difference frame containing data of some drawing blocks of the corresponding reference frame has a data size likely to be delivered to the sink apparatus 102 even if the communication quality is lowered.

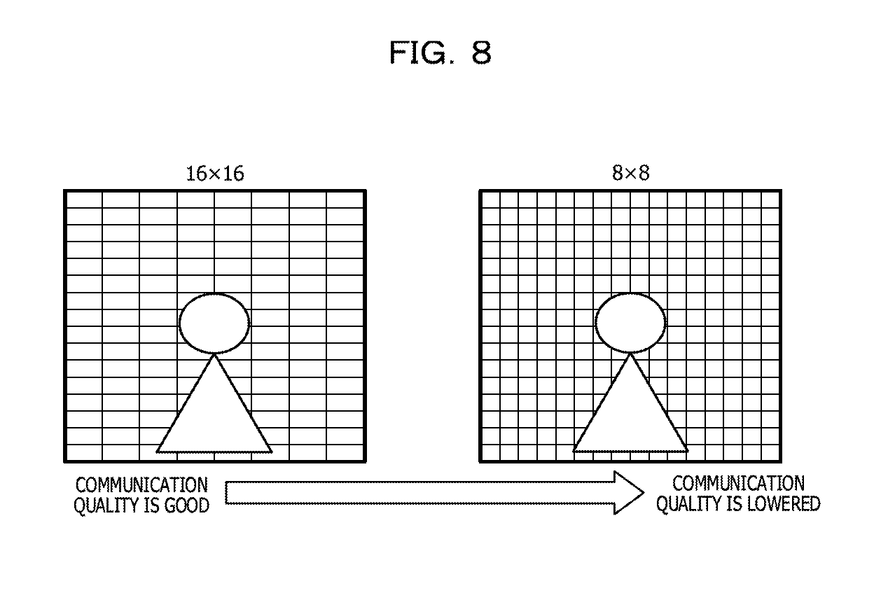

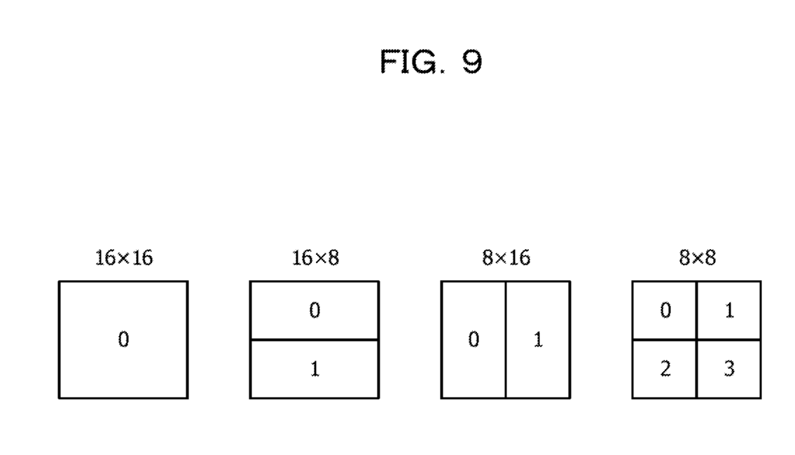

In addition, FIG. 8 is a diagram for further explaining that a data size of data of a reference frame contained in a difference frame is finely adjusted by reducing a block size of a drawing block. As described above, the drawing block may be, for example, a block serving as a unit of coding and may be the macroblock in H.264. In this case, the drawing block is the unit of coding. Therefore, if it is possible to receive data in units of drawing blocks, it is possible for the sink apparatus 102 to draw an image of a corresponding area by decoding data of the drawing blocks. Accordingly, the drawing block is able to be used as a unit of data of the corresponding reference frame contained in the corresponding difference frame. In addition, in a case where the quality of communication between, for example, the source apparatus 101 and the sink apparatus 102 is lowered, the source apparatus 101 changes, to a smaller size, the block size of a drawing block of the corresponding reference frame contained in the corresponding reference difference frame. FIG. 9 is a diagram exemplifying macroblock sizes selectable in H.264 and illustrates macroblock sizes of 16×16 pixels, 16×8 pixels, 8×16 pixels, and 8×8 pixels. In addition, as illustrated in FIG. 8, in a case where, for example, the communication quality is lowered, the control unit 400 in the source apparatus 101 may change, from 16×16 pixels to 8×8 pixels serving as a smaller size, the block size of the macroblock of the corresponding reference frame contained in the corresponding difference frame. In this way, the block size of the macroblock of the corresponding reference frame contained in the corresponding difference frame is changed to a smaller size. Accordingly, it becomes possible to finely adjust the data size of the corresponding difference frame into which a part of data of the corresponding reference frame is inserted. Therefore, it is possible to reduce, for example, the data size of a transmitted frame, and from this, it is possible to enhance the possibility that the corresponding difference frame containing the part of data of the corresponding reference frame is normally delivered to the sink apparatus 102.

In addition, furthermore, in a case where the communication quality is lowered and a part of data of the corresponding reference frame is contained in the corresponding difference frame and transmitted, the control unit 400 in the source apparatus 101 may lower the picture quality of video data of a content, thereby reducing a bit rate, and may perform coding. Note that the bit rate may be, for example, a value expressing a data amount of the video data per second. As an example, by coding a video of full HD (the number of pixels of 1920×1080) into 720 p (the number of pixels of 1280×720), it is possible to reduce a data size per frame and to reduce the bit rate. Therefore, it is possible to enhance the possibility that the corresponding difference frame containing a part of data of the corresponding reference frame is delivered to the sink apparatus 102. Alternatively, by reducing the bit rate, the number of, for example, drawing blocks contained in the corresponding reference frame is decreased. Therefore, it is possible to decrease the number of drawing blocks contained in the corresponding difference frame and transmitted. Accordingly, in a case where, for example, the communication quality is lowered and the video is disturbed, it is possible to accelerate restoration of the video.

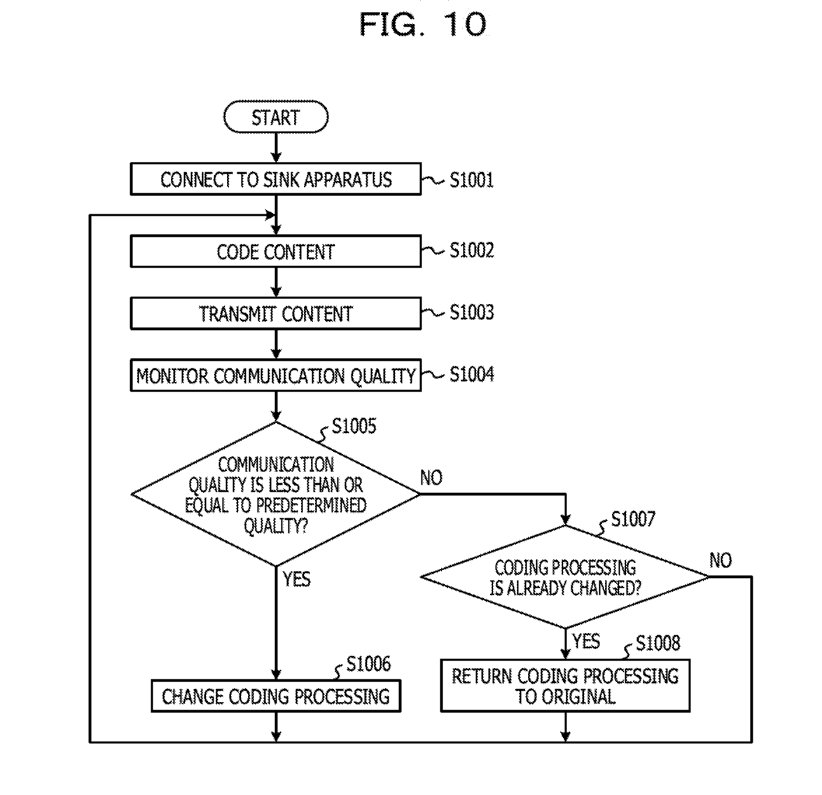

FIG. 10 is a diagram exemplifying an operation flow of transmission processing of contents, performed by the control unit 400 in the source apparatus 101 according to the first embodiment. The flow of transmission processing of contents in FIG. 10 may be started if an instruction for reproducing a content, which is to be transmitted by streaming to the sink apparatus 102, is received by the source apparatus 101.

In a step 1001 (hereinafter, a step is described as “S” and is expressed as, for example, S1001), the control unit 400 in the source apparatus 101 establishes a connection with, for example, the sink apparatus 102. The control unit 400 in the source apparatus 101 may establish a connection with the sink apparatus 102 by using, for example, Wi-Fi Direct. In S1002, the control unit 400 in the source apparatus 101 codes a content. The control unit 400 in the source apparatus 101 may capture and resize, for example, a video decoded from the content and may code the video into the MPEG2-TS container format along with audio data. In S1003, the control unit 400 in the source apparatus 101 transmits the coded data to the sink apparatus 102. In S1004, the control unit 400 in the source apparatus 101 monitors the communication quality of communication with the sink apparatus 102. In S1004, the control unit 400 in the source apparatus 101 may confirm the communication quality at, for example, a given timing, and the communication quality may be, for example, the link speed, the packet loss rate, the packet retransmission rate, or the like.

In S1005, the control unit 400 in the source apparatus 101 determines whether or not the communication quality is lowered to be less than or equal to a predetermined quality. In a case where the link speed is less than or equal to, for example, a first threshold value, the control unit 400 in the source apparatus 101 may determine that the communication quality is less than or equal to the predetermined quality. Alternatively, in a case where the packet loss rate is greater than or equal to a second threshold value, the control unit 400 in the source apparatus 101 may determine that the communication quality is less than or equal to the predetermined quality. In addition, in another embodiment, in a case where the packet retransmission rate is greater than or equal to a third threshold value, the control unit 400 in the source apparatus 101 may determine that the communication quality is less than or equal to the predetermined quality. Alternatively, by combining these determination operations based on the link speed, the packet loss rate, and the packet retransmission rate, the control unit 400 in the source apparatus 101 may determine whether or not the communication quality is less than or equal to the predetermined quality. In, for example, a case where the link speed is less than or equal to the first threshold value or the packet loss rate is greater than or equal to the second threshold value, the control unit 400 in the source apparatus 101 may determine that the communication quality is less than or equal to the predetermined quality.

In a case where, in S1005, it is determined that the communication quality is less than or equal to the predetermined quality (S1005: Yes), the flow proceeds to S1006. In S1006, the control unit 400 in the source apparatus 101 changes coding processing of the currently reproduced content to a setting in a case where the communication quality is lowered. In this changing of the coding processing, the control unit 400 may change the coding processing so as to cause a part of data (for example, a macroblock unit of data) of, for example, the corresponding reference frame most recently transmitted to the sink apparatus 102 to be contained in the corresponding difference frame and to perform coding. In addition, in this changing of the coding processing, in a case of causing the part of data of the corresponding reference frame to be contained in the corresponding difference frame and transmitting the part of data of the corresponding reference frame, the control unit 400 in the source apparatus 101 may change, to a smaller block size, the size of a drawing block of the corresponding reference frame contained in the corresponding difference frame. Furthermore, in this changing of the coding processing, the control unit 400 in the source apparatus 101 may decrease the bit rate of the video data in accordance with, for example, the communication quality. If, in S1006, the control unit 400 in the source apparatus 101 changes the coding processing of the content, the flow returns to S1002. In addition, based on the changed coding processing, the control unit 400 may perform the coding of the content in S1002.

On the other hand, in a case where, in S1005, it is determined that the communication quality is not less than or equal to the predetermined quality (S1005: No), the flow proceeds to S1007. In S1007, the control unit 400 determines whether or not the coding processing of the content is already changed to the setting in a case where the communication quality is lowered. If the coding processing of the content is not already changed to the setting in a case where the communication quality is lowered (S1007: No), the flow returns to S1002. Note that, in this case, it may be thought that the communication quality of communication between, for example, the source apparatus 101 and the sink apparatus 102 is good.

On the other hand, if, in S1007, it is determined that the coding processing of the content is already changed to the setting in a case where the communication quality is lowered (S1007: Yes), the flow proceeds to S1008. In S1008, the control unit 400 returns the coding processing from the setting in a case where the communication quality is lowered, to an original setting. In a case of, for example, causing the part of data of the corresponding reference frame to be contained in the corresponding difference frame and transmitting, to the sink apparatus 102, the part of data of the corresponding reference frame, in S1008 the control unit 400 in the source apparatus 101 may stop inserting the part of data of the corresponding reference frame into the corresponding difference frame. In addition, in a case of changing, to a smaller block size, the size of a drawing block of the corresponding reference frame contained in the corresponding difference frame, in S1008 the control unit 400 in the source apparatus 101 may return the size of the drawing block to an original size before the changing thereof. Furthermore, in a case of decreasing the bit rate in accordance with, for example, the communication quality, in S1008 the control unit 400 in the source apparatus 101 may return the changed bit rate to an original bit rate. If the control unit 400 in the source apparatus 101 returns the coding processing of the content to the original one, the flow returns to S1002. Note that if transmission of the content is completed, the control unit 400 in the source apparatus 101 may terminate the present operation flow.

In S1002 of the above-mentioned operation flow in FIG. 10, the control unit 400 in the source apparatus 101 may function as, for example, the coding unit 402. Alternatively, in S1002, the control unit 400 in the source apparatus 101 may function as the media reproduction control unit 502, the video control unit 503, the audio control unit 504, the coding unit 505, the packet processing unit 506, and the communication unit 508. In S1003, the control unit 400 in the source apparatus 101 may function as, for example, the transmission unit 420 or the wireless communication unit 520. In the processing operations in S1004 to S1008, the control unit 400 in the source apparatus 101 may function as, for example, the coding control unit 401. Alternatively, in the processing operation in S1004, the control unit 400 in the source apparatus 101 may function as the communication monitoring unit 509, and in the processing operations in S1005 to S1008, the control unit 400 in the source apparatus 101 may function as the coding control unit 507.

As described above, in the first embodiment, upon initiating transmitting a content to the sink apparatus 102, the control unit 400 in the source apparatus 101 monitors the communication quality of communication with the sink apparatus 102. In addition, in a case where the quality of communication with the sink apparatus 102 is lowered to be less than or equal to the predetermined quality, the control unit 400 in the source apparatus 101 causes data of a drawing block within the corresponding reference frame most recently transmitted to be contained in the corresponding difference frame and performs coding thereon, thereby transmitting the data of the drawing block to the sink apparatus 102. Accordingly, it is assumed that lowering of the quality of communication between, for example, the source apparatus 101 and the sink apparatus 102 causes an error to be generated in reception of a reference frame and a video currently reproduced by the sink apparatus 102 is disturbed. In this case, without waiting for reception of, for example, a subsequent reference frame, it is possible for the sink apparatus 102 to redraw a drawing block by using data of the drawing block of the corresponding reference frame contained in the corresponding difference frame, thereby restoring the video.

In addition, in a case where the quality of communication with the sink apparatus 102 is lowered to be less than or equal to the predetermined quality, the control unit 400 in the source apparatus 101 changes, to a smaller block size, the size of a drawing block (for example, a macroblock) used for coding. The control unit 400 in the source apparatus 101 may change, to a smaller block size, the size of, for example, a drawing block of the corresponding reference frame contained in the corresponding difference frame. From this, it is possible to finely adjust the data amount of the drawing block of the corresponding reference frame contained in the corresponding difference frame. Therefore, the control unit 400 in the source apparatus 101 may reduce the data size of, for example, a transmitted frame and may enhance the possibility that the corresponding difference frame containing a part of data of the corresponding reference frame is delivered to the sink apparatus 102. In addition, in a case where the quality of communication with the sink apparatus 102 is lowered to be less than or equal to the predetermined quality, the control unit 400 in the source apparatus 101 may reduce the bit rate of video data, thereby performing coding. From this, the control unit 400 in the source apparatus 101 may reduce the data size of, for example, a transmitted frame and may enhance the possibility that the corresponding difference frame containing the part of data of the corresponding reference frame is delivered to the sink apparatus 102. In addition, by reducing the bit rate, it is possible to decrease the number of, for example, macroblocks contained in the corresponding reference frame. Therefore, it is possible to accelerate redrawing in a case of causing data of the corresponding reference frame to be contained in the corresponding difference frame and transmitting the data of the corresponding reference frame.

Note that in a case where, in the above-mentioned S1005, for example, the link speed is less than or equal to the first threshold value or the packet loss rate is greater than or equal to the second threshold value, the control unit 400 may determine that the communication quality is less than or equal to the predetermined quality. The link speed tends to be lowered in, for example, a case where a distance from, for example, the sink apparatus 102 is increased, and there is the possibility that an transmission error of a packet is generated by the lowering of the link speed. On the other hand, even in a case where the link speed is, for example, a favorable speed, if communication in a similar frequency band is performed around, a transmission error of a packet turns out to be generated by radio wave interference in some cases. Therefore, the lowering of the communication quality is determined based on evaluation indexes such as, for example, the link speed and the packet loss rate, thereby enabling the lowering of the communication quality to be more reliably detected.

As described above, according to the first embodiment, in a case where, owing to, for example, the lowering of the communication quality, disturbances are generated in a video received and output by an output device, it is possible promptly restore the video.

### Second Embodiment

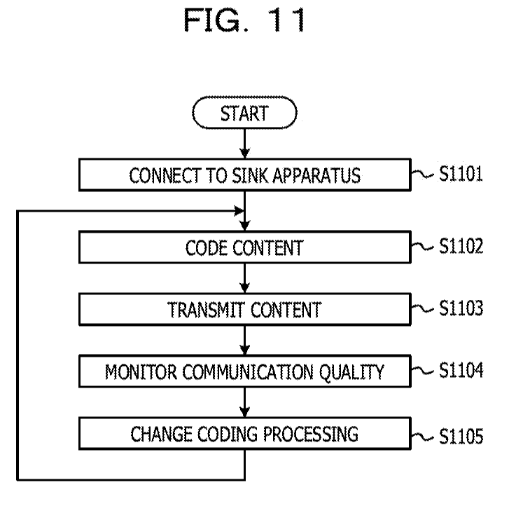

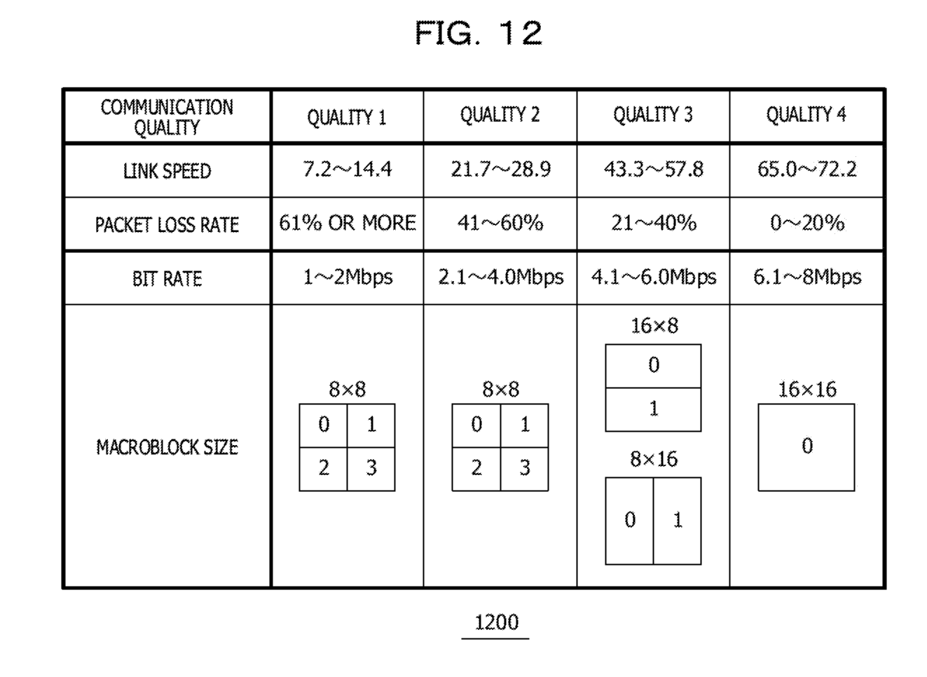

In the first embodiment, there is explained an embodiment in which the coding processing is changed to a setting in a case of lowering of the communication quality if the quality of communication between the source apparatus 101 and the sink apparatus 102 is lowered to be less than or equal to the predetermined quality. However an embodiment is not limited to this. In accordance with, for example, the communication quality, the control unit 400 may control the coding processing in a stepwise manner. Hereinafter, transmission processing of contents according to a second embodiment will be described with reference to FIG. 11 and FIG. 12.

FIG. 11 is a diagram exemplifying an operation flow of transmission processing of contents according to the second embodiment, performed by the control unit 400 in the source apparatus 101. The operation flow of the transmission processing of contents in FIG. 11 may be started if an instruction for reproducing a content, which is to be transmitted by streaming to the sink apparatus 102, is received by the source apparatus 101.

In S1101, the control unit 400 in the source apparatus 101 establishes a connection with, for example, the sink apparatus 102. The control unit 400 in the source apparatus 101 may establish a connection with the sink apparatus 102 by using, for example, Wi-Fi Direct. In S1102, the control unit 400 in the source apparatus 101 codes a content. The control unit 400 in the source apparatus 101 may capture and resize, for example, a video decoded from the content and may code the video into the MPEG2-TS container format along with audio data. In S1103, the control unit 400 in the source apparatus 101 transmits the coded data to the sink apparatus 102. In S1104, the control unit 400 in the source apparatus 101 monitors the communication quality of communication with the sink apparatus 102. In S1104, the control unit 400 in the source apparatus 101 may confirm the communication quality at, for example, a given timing, and the communication quality may be, for example, the link speed, the packet loss rate, or the packet retransmission rate. In S1105, in accordance with the detected communication quality, the control unit 400 in the source apparatus 101 changes coding processing of the currently reproduced content. In the second embodiment, the control unit 400 may reference, for example, the coding setting information 1200 and may acquire a setting of the coding processing corresponding to the communication quality.

FIG. 12 is a diagram exemplifying the coding setting information 1200 according to the second embodiment. In the coding setting information 1200, value ranges of the link speed and the packet loss rate are included while being associated with the communication quality. In FIG. 12, a quality 1 serving as the worst communication quality is registered at the leftmost side, and a quality 2, a quality 3, and a quality 4, which each serve as a higher communication quality, are registered in order from the quality 1 to right. In addition, in each of the link speed and the packet loss rate, value ranges corresponding respective qualities of the quality 1 to the quality 4 are registered. In addition, furthermore, the coding setting information 1200 includes settings of the coding processing, changed in accordance with the communication quality, and for example, respective bit rates and respective macroblock sizes of coding are included therein while being associated with the quality 1 to the quality 4. In addition, in S1105, the control unit 400 in the source apparatus 101 identifies the communication quality whose vale ranges include, for example, the link speed and the packet loss rate, detected in S1104. Note that in a case where communication qualities identified by the link speed and the packet loss rate are different, the control unit 400 may identify, as an example, a worse communication quality as the current communication quality of communication. In, for example, a case where the communication quality identified based on the link speed is the quality 2 and the communication quality identified based on the packet loss rate is the quality 3, the quality 2 may be identified as the current communication quality of communication between the source apparatus 101 and the sink apparatus 102. However, an embodiment is not limited to this, and the control unit 400 may identify, for example, the quality 3 serving as a better communication quality, as the current communication quality of communication between the source apparatus 101 and the sink apparatus 102.

In addition, in S1105, based on the identified communication quality, the control unit 400 in the source apparatus 101 changes the coding processing. It is assumed that the identified communication quality is lowered from, for example, the best communication quality (the quality 4) to another quality. In this case, the control unit 400 in the source apparatus 101 changes the coding processing so as to cause data of some drawing blocks of the finally transmitted reference frame out of the reference frames transmitted to the sink apparatus 102 to be contained in the corresponding difference frame and to perform coding. In addition, the flow returns to S1102, and the control unit 400 in the source apparatus 101 may transmit, to the sink apparatus 102, data of the corresponding difference frame that contains the data of some drawing blocks of the corresponding reference frame and that is coded. Note that in a case where the identified communication quality is the best communication quality (the quality 4), in S1105 the control unit 400 may set the coding processing so as to perform the coding of the corresponding difference frame without causing the data of some drawing blocks of the corresponding reference frame to be contained in the relevant difference frame. In addition, the control unit 400 in the source apparatus 101 may acquire, from the coding setting information 1200, the bit rate and the macroblock size, which correspond to, for example, the identified communication quality, and may change the coding processing so as to use the vales thereof for the coding of the content. If the communication quality identified based on the coding setting information 1200 is, for example, the quality 2, the control unit 400 in the source apparatus 101 may change the coding processing so as to code, at the bit rate of 2.1 to 4.0 Mbps, the content to be transmitted to the sink apparatus 102. In addition, the control unit 400 may change the coding processing so as to perform coding by using 8×8 pixels as the size of a macroblock that is included in the corresponding reference frame and that is to be contained in the corresponding difference frame. If, in S1105, the control unit 400 in the source apparatus 101 changes, in accordance with the communication quality, the coding processing of the currently reproduced content, the flow returns to S1102, and in S1102, the control unit 400 may perform the coding of the content, based on the changed coding processing. Note that if the transmission of the content is completed, the control unit 400 in the source apparatus 101 may terminate the present operation flow.

In S1102 in the above-mentioned operation flow in FIG. 11, the control unit 400 in the source apparatus 101 may function as, for example, the coding unit 402. Alternatively, in S1102, the control unit 400 in the source apparatus 101 may function as the media reproduction control unit 502, the video control unit 503, the audio control unit 504, the coding unit 505, the packet processing unit 506, and the communication unit 508. In S1103, the control unit 400 in the source apparatus 101 may function as, for example, the transmission unit 420 or the wireless communication unit 520. In the processing operations in S1104 and S1105, the control unit 400 in the source apparatus 101 may function as, for example, the coding control unit 401. Alternatively, in the processing operation in S1104, the control unit 400 in the source apparatus 101 may function as the communication monitoring unit 509, and in the processing operation in S1105, the control unit 400 in the source apparatus 101 may function as the coding control unit 507.

As described above, in the second embodiment, in a case where the identified communication quality falls below, for example, the best quality 4, the control unit 400 causes data of some drawing blocks of the corresponding reference frame to be contained in the corresponding difference frame and transmits the data of some drawing blocks to the sink apparatus 102. Therefore, the second embodiment has an advantage achieved by the first embodiment. In addition, furthermore, according to the second embodiment, in accordance with the degree of lowering of the communication quality, the coding processing is changed in a stepwise manner. Therefore, in accordance with, for example, the degree of lowering of the communication quality, it is possible to adequately change the coding processing.

While some embodiments are exemplified as above, embodiments are not limited to the above-mentioned embodiments. While the above-mentioned examples are each described by using, as an example, moving image coding based on, for example, H.264, embodiments are not limited to this. In a case where a video is transmitted to the sink apparatus 102 by using a reference frame and a difference frame, the embodiments may be applicable to another moving image encoding method such as, for example, H.265 (high efficiency video coding (HEVC)). In addition, while the above-mentioned embodiments each illustrate an example in which Miracast is used as a technology for transmitting, to an output device, contents such as a video and an audio, reproduced by a wireless communication device, by using wireless communication and outputting the contents, embodiments are not limited to this. The embodiments may be applied to, for example, another technology for transmitting, to an output device, contents such as a video and an audio, reproduced by a wireless communication device, by using wireless communication and outputting the contents.

In addition, in each of the above-mentioned embodiments, in a case where a part of data of the corresponding reference frame is inserted into the corresponding difference frame, inserted macroblock units of data may be inserted into the corresponding difference frame in the same format as that of coded data of drawing blocks within the corresponding difference frame. In, for example, H.264, drawing blocks within the corresponding difference frame are each coded by using inter coding or intra encoding. In addition, drawing blocks within the corresponding reference frame are coded in the same format as that of the corresponding difference frame by using intra coding. Therefore, it is possible to cause data of drawing blocks of the corresponding reference frame to be contained in the coded data of the corresponding difference frame, the data of drawing blocks of the corresponding reference frame being coded in the same format as the coding format of drawing blocks of the corresponding difference frame. In addition, the sink apparatus 102 decodes, in units of, for example, drawing blocks, the received coded data of the corresponding difference frame and displays an image. Therefore, the sink apparatus 102 is able to perform, in the same way as coded data of drawing blocks within the corresponding difference frame, decoding processing of the data of drawing blocks of the corresponding reference frame contained in the corresponding difference frame and to display on a display screen.

In addition, the operation flows in, for example, FIG. 10 and FIG. 11 are exemplified, and embodiments are not limited to these. If possible, in each of the operation flows in, for example, FIG. 10 and FIG. 11, the order of processing may be changed, another processing operation may be further included, and some processing operations may be omitted.

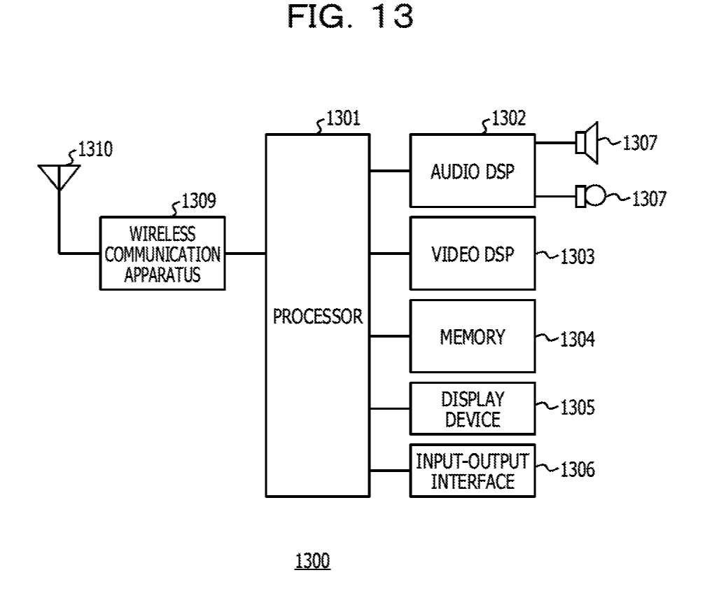

In addition, the source apparatus 101 according to each of the embodiments may be implemented as a hardware circuit and may be realized by using an information processing device (computer) 1300, illustrated in, for example, FIG. 13 and equipped with a wireless communication function. Note that the information processing device 1300 may be a wireless communication device such as, for example, a smartphone, a mobile phone, or a tablet terminal. The information processing device 1300 may include, for example, a processor 1301, an audio digital signal processor (DSP) 1302, a video DSP 1303, and a memory 1304. In addition, the information processing device 1300 may include, for example, a display device 1305, an input-output interface 1306, a receiver 1307, a microphone 1308, a wireless communication apparatus 1309, and an antenna 1310. The processor 1301 may be connected to, for example, the audio DSP 1302, the video DSP 1303, the memory 1304, the display device 1305, the input-output interface 1306, and the wireless communication apparatus 1309.

The processor 1301 may control individual units in the information processing device 1300. In accordance with, for example, an instruction of the processor 1301, the audio DSP 1302 processes an audio signal output by the receiver 1307 and an audio signal input via the microphone 1308. In addition, in accordance with, for example, an instruction of the processor, the audio DSP 1302 may code and decode the audio data of contents. In accordance with, for example, an instruction of the processor, the video DSP 1303 may code and decode the video data of contents.

The wireless communication apparatus 1309 may process signals transmitted and received by, for example, the antenna 1310. In accordance with, for example, an instruction of the processor 1301, the wireless communication apparatus 1309 may transmit, to the sink apparatus 102 via the antenna 1310 by using wireless communication, packets including the audio data and the video data, processed by the audio DSP 1302 and the video DSP 1303.

The processor 1301 may use, for example, the memory 1304 and run a program to perform the procedures mentioned above to control the audio DSP 1302 and the video DSP 1303 and perform the processing operations of the above-mentioned operation flows.

The memory 1304 may be, for example, a semiconductor memory and may include a RAM area and a ROM area. Note that the RAM is the abbreviation of a random access memory. The ROM is the abbreviation of a read only memory. The ROM area may be a semiconductor memory such as, for example, a flash memory. Note that the information processing device 1300 may further include, for example, a reading device that accesses a portable recording medium in accordance with an instruction of the processor 1301. The portable recording medium may be realized by, for example, a semiconductor device (a USB memory, an SD memory card, or the like), a medium to and from which information is input and output based on a magnetic action (a magnetic disk or the like), a medium to and from which information is input and output based on an optical action (a CD-ROM, a DVD, or the like), or the like. Note that the USB is the abbreviation of a universal serial bus. The CD is the abbreviation of a Compact Disc. The DVD is the abbreviation of a Digital Versatile Disk.

The input-output interface 1306 is an interface with, for example, an input device and an output device. The input device may be a device such as, for example, an input key or a touch panel, used for receiving an input from a user. The output device may be, for example, a speaker, a printing device, or the like. The display device 1305 may be, for example, a display, a touch panel, or the like. Note that in a case where an input device connected to the display device 1305 and the input-output interface 1306 is, for example, a touch panel, the display device 1305, the input-output interface 1306, and the input device may be integrated with one another.

In addition, programs according to the embodiments, used for causing the information processing device 1300 to perform the above-mentioned operation flows, may be each provided to the information processing device 1300 in, for example, the following form:

(1) being preliminarily installed in the memory 1304,

(2) being provided by a portable recording medium, or

(3) being provided by a server such as a program server via a network.

Note that, in an embodiment, the above-mentioned control unit 400 may include, for example, the processor 1301, the audio DSP 1302, and the video DSP 1303. For example, the coding control unit 401, the input control unit 501, the media reproduction control unit 502, the packet processing unit 506, the coding control unit 507, the communication unit 508, and the communication monitoring unit 509, described above, may be the processor 1301. In addition, the audio control unit 504 may be, for example, the audio DSP 1302. The coding unit 402, the video control unit 503, and the coding unit 505 may be the video DSP 1303. The transmission unit 420 and the wireless communication unit 520 may be, for example, the wireless communication apparatus 1309. The storage unit 103 may be, for example, the memory 1304 and may store therein the programs in which the procedures of the above-mentioned operation flows are described, contents, the coding setting information 1200, and so forth. The display unit 105 may be, for example, the display device 1305.

In addition, in another embodiment, some functions or all the functions of the above-mentioned control unit 400 in the source apparatus 101 may be installed as hardware based on an FPGA or an SoC. Note that the FPGA is the abbreviation of a field programmable gate array. The SoC is the abbreviation of a system-on-a-chip.

It is understood by those skilled in the art that some embodiments including the above-mentioned embodiments include various modified forms and alternative forms of the above-mentioned embodiments. Various embodiments may be brought into shape by modifying, for example, configuration elements. In addition, various embodiments may be implemented by arbitrarily combining configuration elements disclosed in the above-mentioned embodiments. Furthermore, various embodiments may be implemented by deleting or substituting some configuration elements out of all the configuration elements illustrated in the embodiments or by adding some configuration elements to the configuration elements illustrated in the embodiments.

All examples and conditional language recited herein are intended for pedagogical purposes to aid the reader in understanding the invention and the concepts contributed by the inventor to furthering the art, and are to be construed as being without limitation to such specifically recited examples and conditions, nor does the organization of such examples in the specification relate to a showing of the superiority and inferiority of the invention. Although the embodiments of the present invention have been described in detail, it should be understood that the various changes, substitutions, and alterations could be made hereto without departing from the spirit and scope of the invention.

What is claimed is:

1. A wireless communication device comprising:
a memory; and
a processor coupled to the memory and configured to:
acquire moving image data,
monitor communication quality of wireless communication between an output device and the wireless communication device,
generate, according to first coding processing of the moving image data, first coded data including a reference frame and a first difference frame when the communication quality is greater than a threshold value, the reference frame being coded from intra-frame information, and the first difference frame being coded by referencing the reference frame,
generate, according to second coding processing of the moving image data, second coded data including a second difference frame when the communication quality is less than or equal to the threshold value, the second difference frame being coded by referencing an already-transmitted reference frame already transmitted to the output device and containing data of a block within the already-transmitted reference frame, and
transmit one of the first coded data and the second coded data to the output device using the wireless communication.

2. The wireless communication device according to claim 1, wherein the processor is configured to:
perform the second coding processing by changing a block size of the block within the already-transmitted reference frame contained in the second difference frame from a first size to a second size less than the first size when the communication quality is less than or equal to the threshold value.

3. The wireless communication device according to claim 1, wherein the processor is configured to:
perform the second coding processing by changing a bit rate of the moving image data from a first bit rate to a second bit rate less than the first bit rate when the communication quality is less than or equal to the threshold value.

4. The wireless communication device according to claim 1, wherein the processor is configured to:
perform the second coding processing by changing a block size of the block within the already-transmitted reference frame contained in the second difference frame from a first size to a second size when the communication quality is less than or equal to the first threshold value, and
perform the second coding processing by changing the block size of the block within the already-transmitted reference frame contained in the second difference frame to a third size less than the second size when the communication quality is less than or equal to a second threshold value less than the first threshold value.

5. The wireless communication device according to claim 1, wherein
the communication quality is evaluated based on at least one of a communication speed of the wireless communication and a loss rate of packets in the wireless communication, and
the threshold value is at least one of a value related to the communication speed and another value related to the loss rate.

6. A wireless communication method comprising:
acquiring moving image data;
monitoring communication quality of wireless communication between an output device and the wireless communication device;
generating, according to first coding processing of the moving image data, first coded data including a reference frame and a first difference frame when the communication quality is greater than a threshold value, the reference frame being coded from intra-frame information, and the first difference frame being coded by referencing the reference frame;
generating, according to second coding processing of the moving image data, second coded data including a second difference frame when the communication quality is less than or equal to the threshold value, the second difference frame being coded by referencing an already-transmitted reference frame already transmitted to the output device and containing data of a block within the already-transmitted reference frame; and
transmitting one of the first coded data and the second coded data to the output device using the wireless communication.

7. The wireless communication method according to claim 6, further comprising:
performing the second coding processing by changing a block size of the block within the already-transmitted reference frame contained in the second difference frame from a first size to a second size less than the first size when the communication quality is less than or equal to the threshold value.

8. The wireless communication method according to claim 6, further comprising:
performing the second coding processing by changing a bit rate of the moving image data from a first bit rate to a second bit rate less than the first bit rate when the communication quality is less than or equal to the threshold value.

9. The wireless communication method according to claim 6, further comprising:
performing the second coding processing by changing a block size of the block within the already-transmitted reference frame contained in the second difference frame from a first size to a second size when the communication quality is less than or equal to the first threshold value; and
performing the second coding processing by changing the block size of the block within the already-transmitted reference frame contained in the second difference frame to a third size less than the second size when the communication quality is less than or equal to a second threshold value less than the first threshold value.

10. The wireless communication method according to claim 6, wherein
the communication quality is evaluated based on at least one of a communication speed of the wireless communication and a loss rate of packets in the wireless communication, and
the threshold value is at least one of a value related to the communication speed and another value related to the loss rate.

11. A non-transitory storage medium storing a wireless communication program causing a computer to execute a process, the process comprising:
acquiring moving image data;
monitoring communication quality of wireless communication between an output device and the wireless communication device;
generating, according to first coding processing of the moving image data, first coded data including a reference frame and a first difference frame when the communication quality is greater than a threshold value, the reference frame being coded from intra-frame information, and the first difference frame being coded by referencing the reference frame;
generating, according to second coding processing of the moving image data, second coded data including a second difference frame when the communication quality is less than or equal to the threshold value, the second difference frame being coded by referencing an already-transmitted reference frame already transmitted to the output device and containing data of a block within the already-transmitted reference frame; and
transmitting one of the first coded data and the second coded data to the output device using the wireless communication.

12. The non-transitory storage medium according to claim 11, wherein the process further comprising:
performing the second coding processing by changing a block size of the block within the already-transmitted reference frame contained in the second difference frame from a first size to a second size less than the first size when the communication quality is less than or equal to the threshold value.

13. The non-transitory storage medium according to claim 11, wherein the process further comprising:
performing the second coding processing by changing a bit rate of the moving image data from a first bit rate to a second bit rate less than the first bit rate when the communication quality is less than or equal to the threshold value.

14. The non-transitory storage medium according to claim 11, wherein the process further comprising:
performing the second coding processing by changing a block size of the block within the already-transmitted reference frame contained in the second difference frame from a first size to a second size when the communication quality is less than or equal to the first threshold value; and
performing the second coding processing by changing the block size of the block within the already-transmitted reference frame contained in the second difference frame to a third size less than the second size when the communication quality is less than or equal to a second threshold value less than the first threshold value.

15. The non-transitory storage medium according to claim 11, wherein
the communication quality is evaluated based on at least one of a communication speed of the wireless communication and a loss rate of packets in the wireless communication, and
the threshold value is at least one of a value related to the communication speed and another value related to the loss rate.
